(19) United States
(12) Patent Application Publication
(10) Pub. No.: US 2025/0086543 A1
(43) Pub. Date: Mar. 13, 2025

(54) INFORMATION PROCESSING DEVICE AND INFORMATION PROCESSING METHOD

(71) Applicant: HITACHI, LTD., Tokyo (JP)

(72) Inventors: Mitsuharu Tai, Tokyo (JP); Alessia Masola, Tokyo (JP); Naoki Yoshimoto, Tokyo (JP)

(73) Assignee: HITACHI, LTD., Tokyo (JP)

(21) Appl. No.: 18/827,974

(22) Filed: Sep. 9, 2024

(30) Foreign Application Priority Data
Sep. 11, 2023 (JP) 2023-146902

(51) Int. Cl. G06Q 10/0631; G06Q 50/26

(52) U.S. Cl. CPC G06Q 10/06313; G06Q 50/26

(57) ABSTRACT

Provided is an information processing device that supports formation of agreement by multiple participants. The device includes a memory stores a causal loop diagram database where participant attributes and corresponding causal loop diagrams are accumulated. These causal loop diagrams visualize causal relations between evaluation indicators and causal relation strength. The device also includes a processor that classifies the participants into multiple classes based on input information relating to attributes of the participants and generates class attributes of the classes. The processor refers to the causal loop diagram database based on the class attributes of the classes and creates a class causal loop diagram. The processor extracts a difference regarding the causal relations and the causal relation strength between the class causal loop diagrams and generates difference information. The processor identifies an issue for discussion to form the agreement, based on the difference information, and presents the issue to the participants.

### BACKGROUND OF THE INVENTION

### 1. Field of the Invention

The present disclosure relates to a technique that supports formation of agreement by a plurality of participants.

### 2. Description of the Related Art

In operation of a city including maintenance and management of infrastructure facilities, formulation and execution of city planning, provision of public services, and the like, the influence of the declining birthrate and aging population and/or aging infrastructure becomes more significant as the maturity of the country becomes higher. What kind of service is to be selected and whether to intensively allocate resources to the service within ranges of limited budget and limited human resources are significant problems in countries represented by developed countries including Japan.

Further, transitions are being made from a conventional city operation method led by a national or local government to a method in which a geographical unit of operation, i.e., an area, is configured and constituent members including residents are involved in operation of the area. Among the areas are ones of various units, such as city, town, region, and district. Importance is given to a way of city operation in which stakeholders such as residents are initiatively involved in decision-making of the overall operation main entity. In recent years, there have been increasing attempts in which residents, who have been passive thus far, participate in decision-making in operation of a city or get involved in design of public services through, for example, activities and fields such as living labs or workshops. This is because it is considered that residents making decisions on their own life-settings effectively acts on the sustainability of measures and public services and continuous updating of the city environment and the public services.

In general, as stakeholders who are constituent members configuring the operation main entity of the area, for example, a plurality of stakeholders such as persons who are resident in the area and persons who do business in the area exist, and a wide variety of interests exist for each stakeholder. When interests of a certain stakeholder and another stakeholder conflict with each other or when a condition as a premise of discussion is not aligned among a plurality of stakeholders, a considerable length of time is possibly required until decisions are made by the overall operation main entity, or agreement between the stakeholders is possibly not obtained, so that a measure or a plan gets derailed. To reduce such conflicts between stakeholders, employing the following method is effective. A key performance indicator (KPI) is formulated as an evaluation value for evaluating various effects relating to formulation of a measure, and the numerical value of the KPI is calculated. In this manner, the current condition before execution of the measure is recognized, and the state which will be obtained when the measure is executed is predicted. While effects of the measure are verified, operation of a city is promoted.

For example, multiple KPIs exist in an area such as a town or a city, and these multiple KPIs correlate with each other in a complicated manner in such a form as to be mutually linked to each other by causal relations. There has been proposed a tool that visualizes these multiple KPIs and the causal relations to effectively support or reinforce formulation of a policy for operating the town or the city. For example, JP-2023-034888-A proposes a causal loop diagram (CLD) as a method for visualizing the relation between KPIs. This tool can visually display causal relations between KPIs in a manner suitable for a problem and an issue to which attention should be paid. Moreover, this tool also has an input function that allows a user to correct the causal relation, and can calculate the KPI by using the corrected causal relation and predict effects of a measure while virtually changing the KPI. On that occasion, it becomes possible for a plurality of stakeholders to, by this tool, mutually share a premise of discussion and capture the relation between KPIs to share mutual interests. Thus, it becomes possible for the plurality of stakeholders to efficiently reach agreement.

### SUMMARY OF THE INVENTION

Using the tool of JP-2023-034888-A makes it possible to visualize the causal relations between KPIs by the CLD and advance discussion about formulation of a measure while correcting the causal relation and virtually predicting effects of the measure. This tool visualizes a single CLD, and it is envisaged that a plurality of participants advance discussion while referring to and correcting the single CLD.

However, this tool is not sufficient to eliminate conflict between interests of a plurality of participants and deviation of a condition as a premise of discussion in the process of obtaining the CLD to which the plurality of participants can agree in common.

In general, for example, subjective indicators such as the quality of life (QoL), the level of happiness, and the short-term economic survey are included in KPIs set for formulating a measure. The way of feeling by a person regarding the subjective indicator differs if the situation of the person differs, even when the state of the surroundings of the person is the same. Therefore, there is a possibility that the numerical value of the subjective indicator differs depending on the situation.

If the subjective indicators are excluded from the KPIs for formulating a measure, it becomes possible to create a universal CLD that does not depend on the situation. However, originally, for example, improvement in the subjective indicators, such as improvement in the QoL and improvement in the level of happiness, is one of major goals for measures and public services of a city. Therefore, there is a possibility that the exclusion of the subjective indicators from the KPIs for formulating a measure does not necessarily effectively contribute to formation of agreement toward the major goals.

One object included in the present disclosure is to provide a technique that more effectively supports formation of agreement.

An information processing device according to one aspect included in the present disclosure is an information processing device that supports formation of agreement by a plurality of participants, the information processing device including a processor, and a memory that stores a causal loop diagram database in which attributes of participants and causal loop diagrams that conform to the attributes are accumulated in association with each other. The causal loop diagrams visualize causal relations between evaluation indicators and causal relation strength that represents strength of the causal relations. The processor classifies the plurality of participants into a plurality of classes on the basis of input information relating to attributes of the plurality of participants and generates class attributes indicating attributes of each of the plurality of classes, and refers to the causal loop diagram database on the basis of the class attributes of the plurality of classes and creates a class causal loop diagram that is a causal loop diagram of each of the classes. The processor further extracts a difference regarding the causal relations and the causal relation strength between a plurality of the class causal loop diagrams and generates difference information indicating the difference, identifies an issue to be discussed to form the agreement, on the basis of the difference information, and presents the issue to the participants.

According to the one aspect included in the present disclosure, the issue that should be discussed is identified on the basis of the difference in the causal relations between the evaluation indicators of each of the classes into which the participants are classified. Therefore, it becomes possible to effectively support formation of agreement by the plurality of participants.

### BRIEF DESCRIPTION OF THE DRAWINGS

FIG. 1 is a configuration diagram of a CLD visualization system;

FIG. 2 is a diagram illustrating a flow of information in the CLD visualization system in agreement formation support;

FIG. 3 is a diagram illustrating a flow of processing in the CLD visualization system in the agreement formation support;

FIG. 4 is a diagram illustrating one example of data stored in a CLD database;

FIG. 5 is a diagram illustrating CLDs of a case A and a case B reproduced from the data of FIG. 4;

FIG. 6 is a diagram for explaining calculation of a difference between the CLDs;

FIG. 7 is a diagram illustrating one example of data of cases stored in a case database;

FIG. 8 is a diagram illustrating a flow of information in the CLD visualization system in database expansion;

FIG. 9 is a diagram illustrating a flow of processing in the CLD visualization system in the database expansion;

FIG. 10 is a diagram illustrating one example of screen transition on a participant terminal at the time of CLD correction by a participant; and

FIG. 11 is a block diagram illustrating a configuration of a workshop operation system.

### DESCRIPTION OF THE PREFERRED EMBODIMENT

An embodiment of the present invention will be described below with use of the drawings. Although specific working examples of the present invention will be illustrated in the following description, they are examples for understanding of the present invention, and the present invention is not limited by the category of the drawings.

A CLD visualization system of the present embodiment is an information processing device that supports formation of agreement by a plurality of participants by generating a causal loop diagram (CLD) and providing the CLD to a planner and participants. The “planner” mentioned here refers to a person who plans a living lab or a workshop and facilitates a meeting therein. Further, the “participants” mentioned here refer to stakeholders who participate in the living lab or the workshop.

The CLD visualization system of the present embodiment provides a CLD repository function that saves in advance CLD groups obtained by collecting a plurality of CLDs and that can sequentially calculate the necessary CLD group when information on attributes of the participants is input, and a problem search function that receives the calculated CLD group and extracts a difference between CLDs to extract an issue that should be discussed on the basis of the difference. The CLD visualization system also provides a visualization function that visualizes a database in which the calculated CLD group, the difference between CLDs, and information on the issue are recorded, in such a manner as to allow operation by the planner on a terminal of the planner, and a visual user interface that allows the planner to correct the database.

### Outline of System

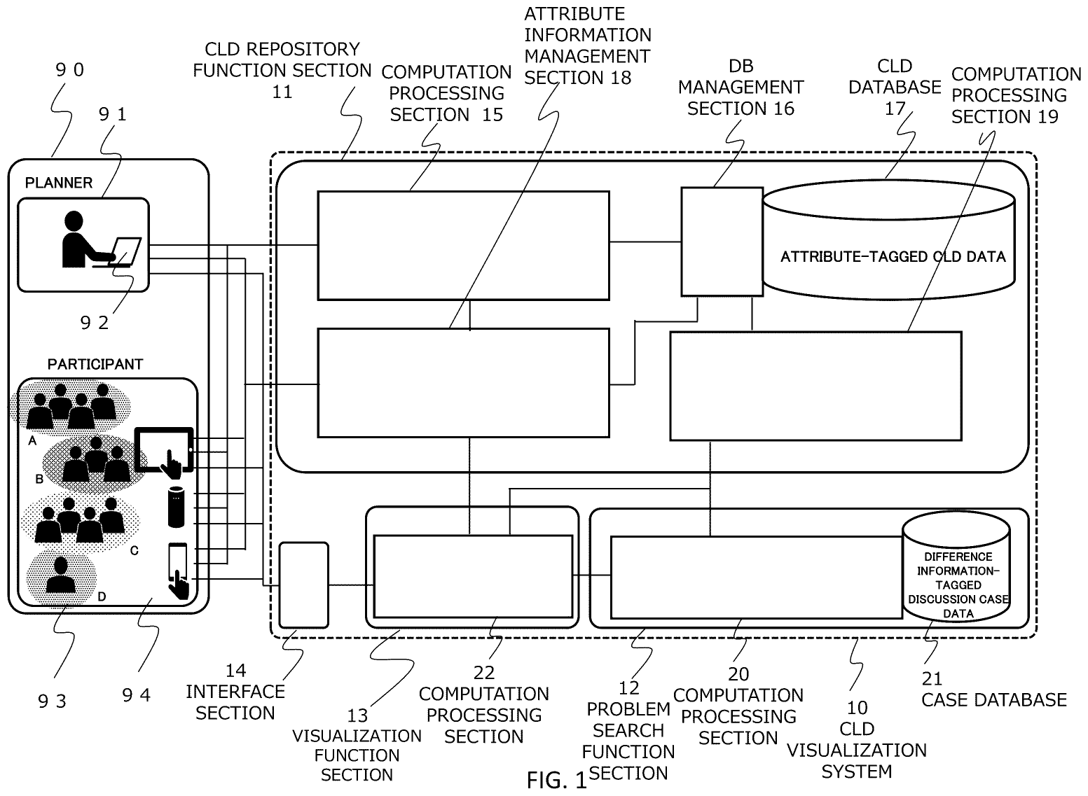

FIG. 1 is a configuration diagram of the CLD visualization system of the present embodiment.

A CLD visualization system 10 can be operated from a planner terminal 92 by a planner 91 who plans a workshop and facilitates a meeting in a workshop/meeting 90, and can be accessed from participant terminals 94 by participants 93 who participate in the workshop and the meeting.

The CLD visualization system 10 has a CLD repository function section 11 that implements the above-described CLD repository function, a problem search function section 12 that implements the above-described problem search function, a visualization function section 13 that implements the above-described visualization function, and an interface section 14 that implements the above-described user interface.

The CLD repository function section 11 has a database management section 16, an attribute information management section 18, a CLD database 17, and computation processing sections 15 and 19.

The CLD database 17 stores data of various CLDS. With the CLD in this CLD database 17, attributes of a class to which participants at the time of use of this CLD belong are associated. The attributes of the participants and/or the attributes of the class are, for example, the gender, the age, the age group, the occupation, the place of residence, the place of work, the income, and the like. Hereinafter, the attributes of the class will be referred to as the class attributes in some cases. The CLD stored in the CLD database 17 is not limited to any particular kind and may be, for example, a CLD used in a living lab or a workshop held in the past, a CLD virtually created, or the like.

The database management section 16 manages writing of the CLD to the CLD database 17 and reading of the CLD from the CLD database 17. For example, when an attribute of participants is specified, the CLD that conforms to the attribute can be extracted from the CLD database 17.

The attribute information management section 18 manages attribute information of participants in a series of processing in a living lab or a workshop. For example, the attribute information management section 18 acquires the attribute information of each participant and records the attribute information in association with the participant.

The computation processing section 15 executes clustering of classifying a plurality of participants into a plurality of classes on the basis of the attributes, and generates the plurality of classes and attributes as the class (that is, class attributes) of each class. The class attributes are attributes that represent the participants who belong to the relevant class.

The computation processing section 19 generates the CLD that conforms to specified attributes, from one or more CLDs extracted from the CLD database 17 on the basis of the attributes. At this time, the computation processing section 19 may select the CLD that conforms to the attributes at the highest degree from among the extracted CLDs. Alternatively, the computation processing section 19 may generate the CLD that conforms to the attributes, by integrating the extracted CLDs.

The problem search function section 12 has a case database 21 and a computation processing section 20. In the case database 21, difference information indicating the difference between CLDs that occurred in a past living lab or workshop and discussion information indicating an issue discussed when the difference occurred and contents of the discussion are accumulated in association with each other. The computation processing section 20 refers to the case database 21 on the basis of given information on the difference and extracts the discussion information that matches the difference.

The visualization function section 13 has a computation processing section 22. The computation processing section 22 executes processing to implement the above-described visualization function. The interface section 14 implements functions of the above-described user interface.

As one example of a hardware configuration, the CLD visualization system 10 of the above-described present embodiment may be a computer having a memory that stores data and a software program and a processor that executes data processing prescribed in the software program.

Further, the data and/or the software program may be stored in a storage medium in advance and be loaded onto the memory as appropriate. The CLD database 17 of the CLD repository function section 11 and the case database 21 of the problem search function section 12 are configured on the memory. Moreover, the database management section 16, the attribute information management section 18, and the computation processing sections 15 and 19 of the CLD repository function section 11, the computation processing section 20 of the problem search function section 12, and the computation processing section 22 of the visualization function section 13 are functional sections implemented through execution of the software program by the processor. These functional sections may be implemented by one processor or be implemented by a plurality of processors.

### Details of System

The CLD visualization system 10 of the present embodiment supports formation of agreement by using data accumulated in the CLD database 17 and the case database 21 (agreement formation support), and expands the CLD database 17 and the case database 21 by data obtained on that occasion (database expansion). Each of the agreement formation support and the database expansion will be described below.

### Agreement Formation Support

Description will be made below about support of formation of agreement by the participants 93 by the CLD visualization system 10 in an actual workshop, a place of formulation of a measure, or the like.

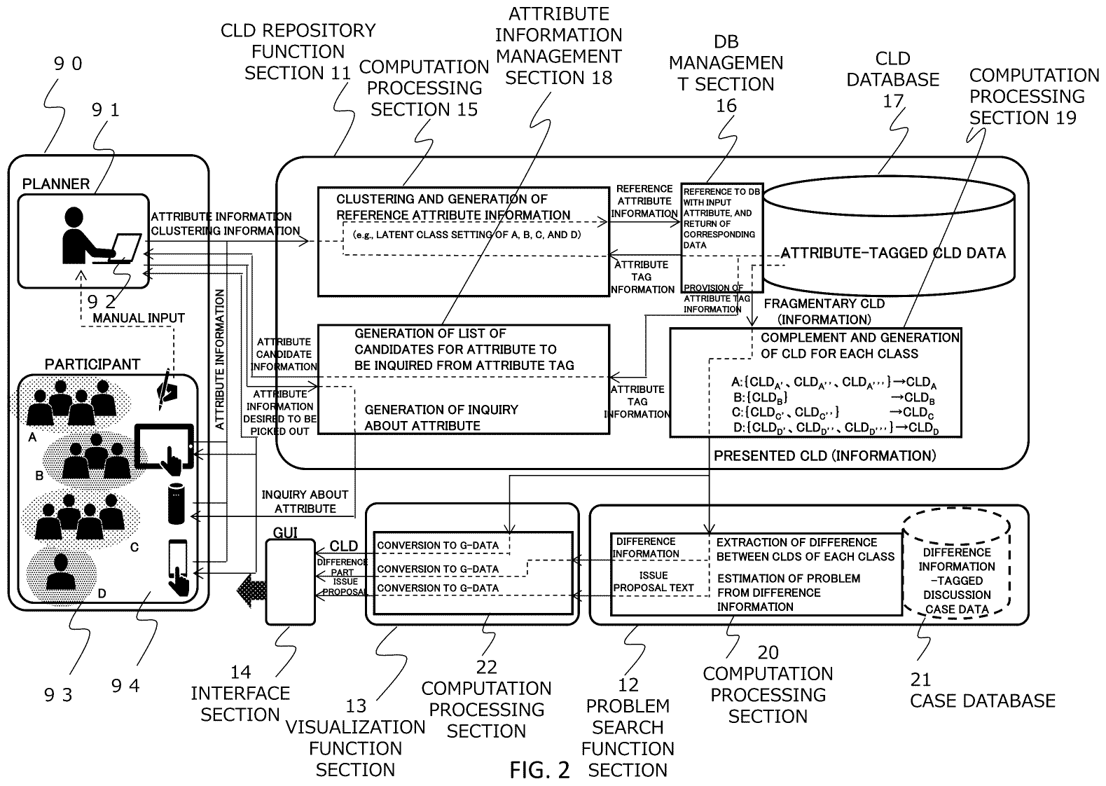

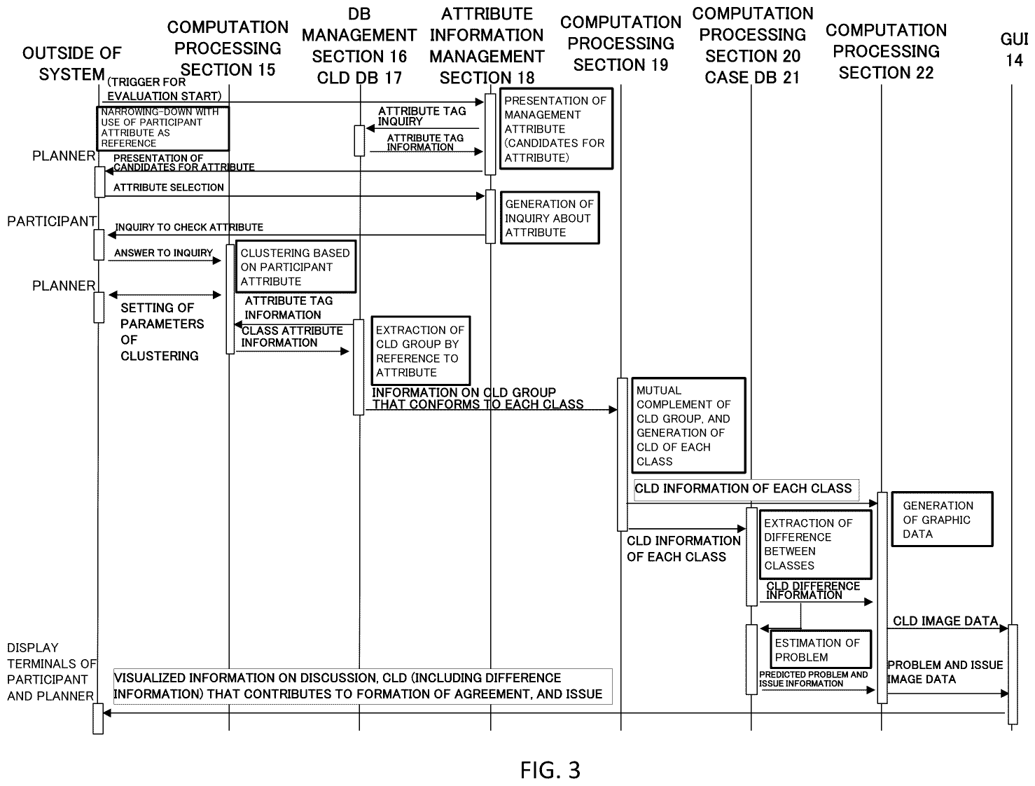

FIG. 2 is a diagram illustrating a flow of information in the CLD visualization system in the agreement formation support. FIG. 3 is a diagram illustrating a flow of processing in the CLD visualization system in the agreement formation support.

The planner 91 gives a trigger for evaluation start to the CLD visualization system 10 in advance. For example, the trigger is inputting, to the CLD visualization system 10, trigger input information including contents of the plan of a workshop and rough attribute information of participants invited to the workshop, or the like. The trigger input information is sent to the attribute information management section 18.

When receiving the trigger input information, the attribute information management section 18 transmits attribute tag inquiry information to the CLD database 17. The attribute tag inquiry information is information for inquiring the attribute information saved in the CLD database 17.

A large number of CLDs given (tagged with) the attribute information are saved in the CLD database 17. The attribute information is information that characterizes a group of stakeholders having the same interest, and is, for example, a combination of the gender, the age or age group, the occupation, the place of residence, the place of work, the income, and the like. The CLD saved in the CLD database 17 does not necessarily need to be a complete form and may be a fragmentary CLD. For example, the CLD and the attribute information having a record of being created for formation of agreement in a workshop, measure formulation, or the like executed in the past are saved in the CLD database 17. Further, the attribute information given to the CLD may be allowed to be added and changed ex-post facto.

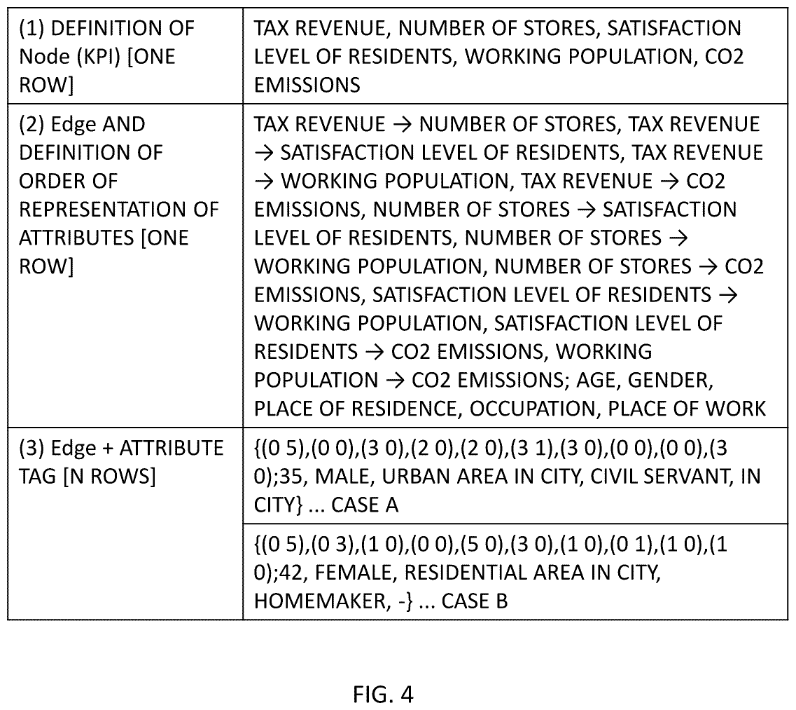

There is no limitation on the method for storing the attribute information and the CLD in the CLD database 17. For example, a storing method as the one illustrated in FIG. 4 is possible.

FIG. 4 is a diagram illustrating one example of data stored in the CLD database.

In the example of FIG. 4, the data of the CLD is managed with three kinds of definition hierarchical levels, (1) to (3). (1) is a layer that defines nodes of the CLD. A node corresponds to a KPI. In the example of FIG. 4, five nodes are illustrated. (2) is a layer that defines edges and the order of representation of attributes. Edges are defined by the total number of combinations from all KPIs. In the example of FIG. 4, ten edges are defined. (3) indicates the value of the weight of each edge and the attribute information regarding each CLD. This (3) is the main body of the data. In the example of FIG. 4, information on two kinds of CLDs of a case A and a case B is stored in (3). The weight of an edge represents the strength of the causal relation. The edge information is expressed by a set of two variables. They represent the weight of the causal relation in the forward direction and the reverse direction.

The CLD can be reproduced from the information of (1) to (3).

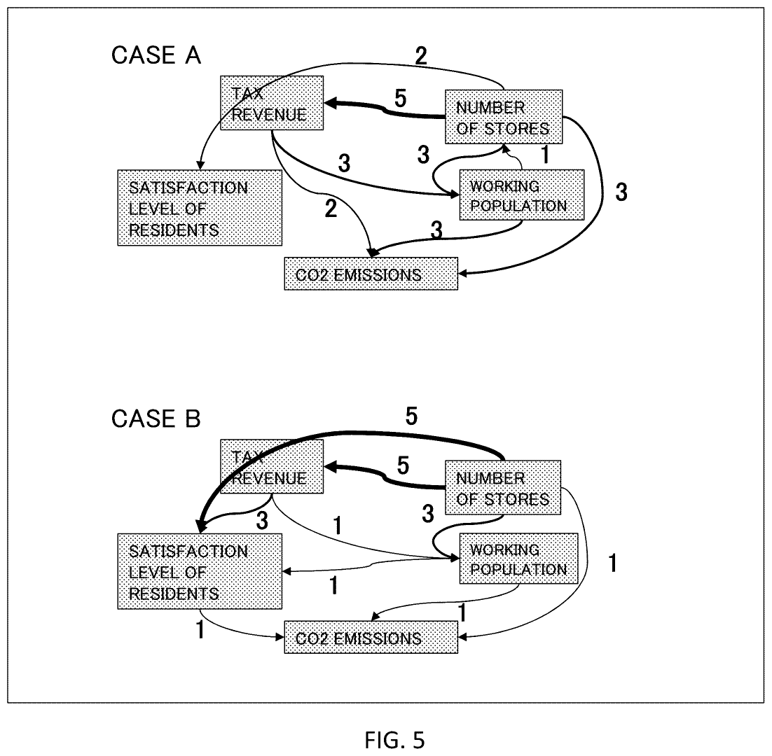

FIG. 5 is a diagram illustrating the CLDs of the case A and the case B reproduced from the data of FIG. 4. In FIG. 5, the direction of an arrow indicates the direction of the causal relation, and a numerical value represented near the arrow indicates the strength of the causal relation indicated by this arrow. In this manner, the CLD can be reproduced from the data of the format of FIG. 4. However, the data format of the CLD is not limited to the format exemplified in FIG. 4 and may be any format as long as it is a data format that allows the CLD to be reproduced by certain processing.

With reference back to FIG. 3, upon receiving the attribute tag inquiry information, the CLD database 17 returns the attribute information with which the CLDs retained by the CLD database 17 are tagged to the attribute information management section 18. The processor of the attribute information management section 18 settles an item of the attribute information that should be inquired of the participants 93 and generates an inquiry on the basis of the attribute information acquired from the CLD database 17 and the rough attribute information included in the trigger input information input by the planner 91 in advance. For example, the attribute information management section 18 may extract all items from the attribute information acquired from the CLD database 17 and the rough attribute information included in the trigger input information input by the planner 91 in advance and propose them as an item proposal of the attribute information that should be inquired of the participants 93. The planner 91 can execute addition, deletion, revision, or the like on the item proposal created by the attribute information management section 18, to correct the inquiry.

When the contents of the inquiry have been settled by approval by the planner 91, the attribute information management section 18 presents the contents of the inquiry to the participants 93 on an occasion of decision-making, such as a workshop or measure formulation, and prompts them to make input.

The participants 93 each input information on attributes of the participant 93 oneself by answering the inquiry presented from the attribute information management section 18 at the place of a workshop or a meeting. Alternatively, the participants 93 may each input information on attributes of the participant 93 oneself by answering an inquiry in advance. The answer may be input from the participant terminal 94 such as a smartphone, a personal computer (PC), a tablet, or an artificial intelligence (AI) speaker of each of the participants 93. Further, the participant 93 may write an answer on paper and submit the paper to the planner 91, and the planner 91 may input the answer from the planner terminal 92.

The input attribute information of each participant 93 is sent to the computation processing section 15. The processor of the computation processing section 15 executes clustering on the basis of the attribute information of each participant 93 to classify the participants 93 into a plurality of classes. The method of the clustering processing is not limited to any particular method. The level of the clustering may be set for the CLD visualization system 10 by the planner 91 or be automatically set. The level of the clustering is the K-value (the number of classes), for example.

Typically, it is preferable that the number of classes be approximately three or four on an occasion of decision-making such as a workshop or measure formulation. However, setting of classes in such a manner that attributes of the participants 93 who belong to the relevant class are similar to each other in each class is more important than the number of classes. In FIG. 2, an example in which the participants 93 are classified into four classes, A, B, C, and D, is illustrated.

Moreover, the computation processing section 15 executes clustering of the attributes associated with the respective CLDs saved in the CLD database 17, to classify the attributes into a plurality of classes. On the basis of the clustering result of the attributes, the database management section 16 sends the CLDs that can be applied to the respective classes generated in the clustering of the participants 93, from the CLD database to the computation processing section 19. In the example illustrated in FIG. 2, three kinds of CLDS, CLD_{A′}, CLD_{A″}, and CLD_{A′″}, exist as the CLDs that can be applied to the class A, and one kind of CLD, CLD_{B}, exists as the CLD that can be applied to the class B. In addition, two kinds of CLDs, CLD_{C′} and CLD_{C″}, exist as the CLDs that can be applied to the class C, and three kinds of CLDs, CLD_{D′}, CLD_{D″}, and CLD_{D′″}, exist as the CLDs that can be applied to the class D.

The CLDs saved in the CLD database 17 are CLDs created and/or decided in past workshops or the like. Therefore, the CLDs have been created on the basis of themes covered in the workshops or the like and the interests of stakeholders who participated in the workshops or the like. Accordingly, in general, the CLDs are too imperfect or fragmentary to be used in the present workshop or the like. The “imperfect” refers to that the values of the KPIs and/or the causal relations forming the CLD are not proper, for example. The “fragmentary” refers to that the KPIs and/or the causal relations forming the CLD are insufficient, for example.

Because the participants 93 with interests similar to each other are classified into the respective classes as described above, the computation processing section 19 creates, for each class, one CLD that reflects the interest of the class. The computation processing section 19 creates one CLD for the relevant class from one or more CLDs extracted from the CLD database 17 as the CLDs that can be applied to this class. When there are multiple CLDs extracted from the CLD database 17, one CLD may be created by merging these multiple CLDs in such a manner that the CLDs complement each other. The complementary technique on that occasion is not limited to any particular technique. For example, the one CLD may be created by employing, as the value of each edge, the arithmetic mean of the weight of each edge (strength of the causal relation) of the multiple CLDs extracted from the CLD database 17. Alternatively, the one CLD may be created by weighting the weight of each edge of the multiple CLDs extracted from the CLD database 17 by the reciprocal of the distance from the centroid of the distribution of the cluster and calculating the average to employ it as the value of each edge. Alternatively, the one CLD may be created by the following technique. The mutual similarities of the multiple CLDs are calculated, and the CLDs regarding which the mutual similarity is equal to or higher than a predetermined threshold are regarded as Majority. Then, the weight of each edge of the CLDs regarded as Majority is evenly and highly weighted, and the average is calculated to employ it as the value of each edge.

The CLD calculated for each class is sent to the computation processing section 20 of the problem search function section 12 and the computation processing section 22 of the visualization function section 13.

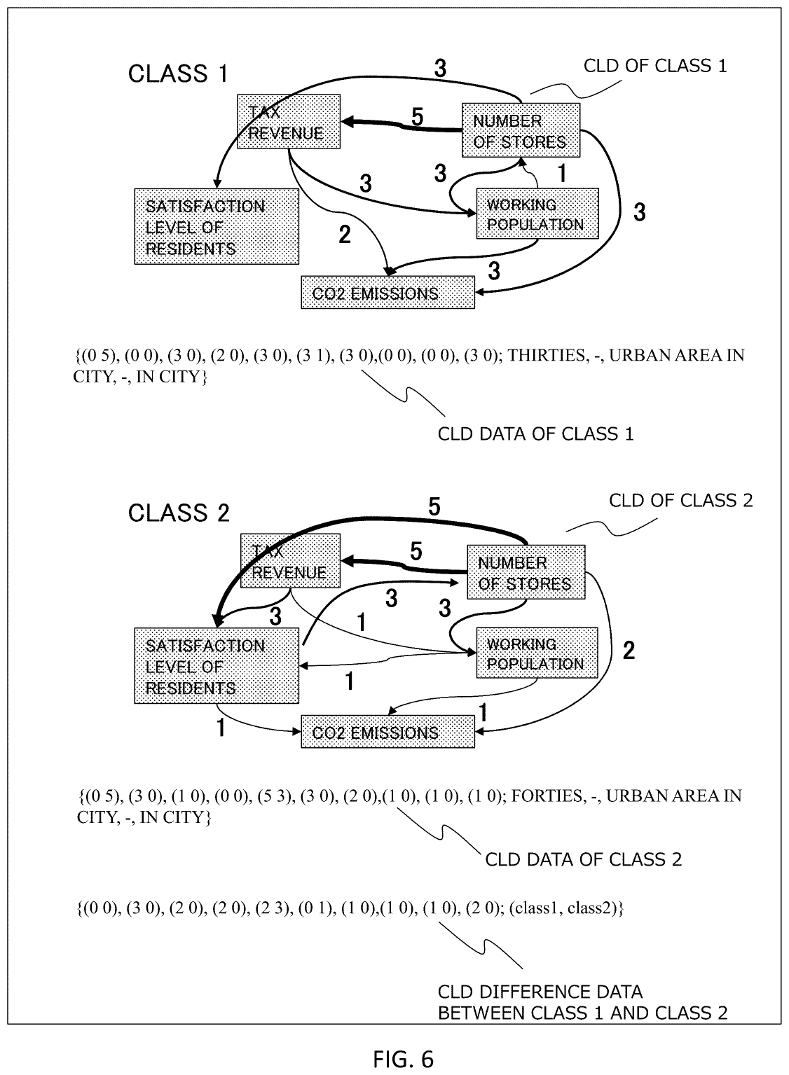

The computation processing section 20 compares the structures of the CLD of each class and calculates the difference. FIG. 6 is a diagram for explaining the calculation of the difference between the CLDs. FIG. 6 illustrates an example in which data of the difference between a CLD of class 1 and a CLD of class 2 is expressed in the data format illustrated in FIG. 4. Here, the data format in which the values of the difference in the weight of each edge and the class names of the compared two classes are lined up is illustrated. However, the method for quantifying the difference or converting the difference to data is not limited thereto.

Moreover, the computation processing section 20 searches for the case in the case database 21 on the basis of this difference information, and acquires the case of an issue discussed when the relevant difference occurred and the contents of the discussion. In the case database 21, the difference information indicating the difference between CLDs that occurred in a past living lab or workshop is given as a tag to the discussion information indicating an issue discussed when the difference occurred and the contents of the discussion, and the discussion information tagged with the difference information is accumulated.

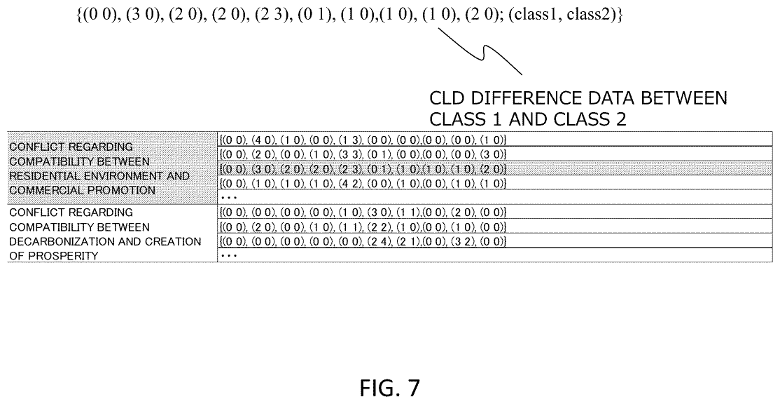

FIG. 7 is a diagram illustrating one example of data of the cases stored in the case database. In the example of FIG. 7, data of two cases, “conflict regarding compatibility between residential environment and commercial promotion” and “conflict regarding compatibility between decarbonization and creation of prosperity,” is illustrated. Each case is associated with a plurality of difference information tags. These pieces of difference information indicate the difference between CLDs in a CLD group presented in a workshop or the like in which the relevant case was discussed.

It is envisaged that a similar issue becomes an important issue in a workshop or the like in which the same or similar difference has occurred. Thus, an issue and the contents of discussion in a past workshop or the like in which the difference that was the same as or similar to the difference that has occurred in the present workshop or the like occurred will serve as a reference. Extracted from the example of FIG. 7 is the case of “conflict regarding compatibility between residential environment and commercial promotion” indicated by hatching in FIG. 7 in a past workshop or the like in which the same difference as the difference in the present workshop or the like occurred. The computation processing section 20 extracts the hatching part from the case database 21 and outputs text of “conflict regarding compatibility between residential environment and commercial promotion.” Note that a plurality of cases may be tagged with the same difference. Therefore, it is also possible that cases of a plurality of issues are extracted although one case is extracted in the example of FIG. 7. The computation processing section 20 outputs all of them, and the cases are utilized as problems estimated in the present workshop or the like.

The CLDs extracted from the CLD database 17, the CLD of each class generated from these CLDs, the difference information indicating the difference between the CLDs of each class, and the information on the issue and the contents of discussion of the case extracted from the case database 21 are all sent to the computation processing section 22 of the visualization function section 13.

In the visualization function section 13, the computation processing section 22 converts these pieces of information to visualized data, and the visualized data is transmitted to the participant terminals 94 through the interface section 14 and is presented to the participants 93.

### Database Expansion

Description will be made below about expansion of the databases of the CLD visualization system 10 by use of data obtained in an actual workshop, a place of formulation of a measure, or the like.

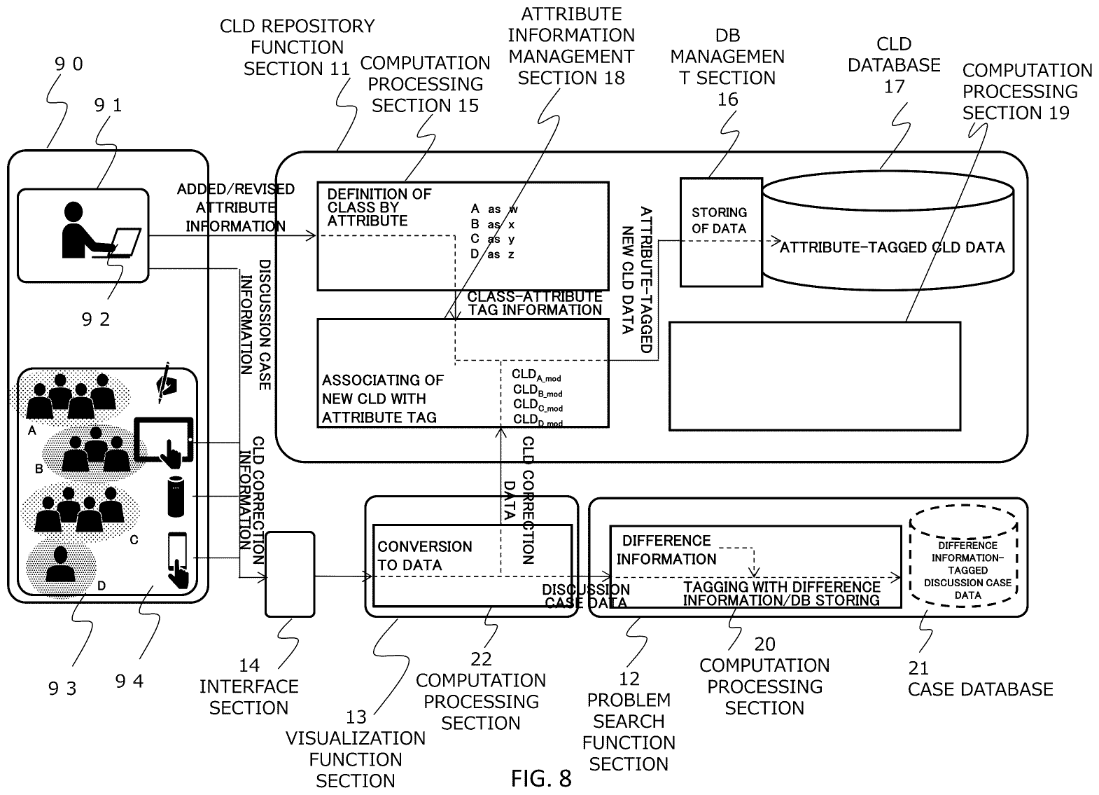

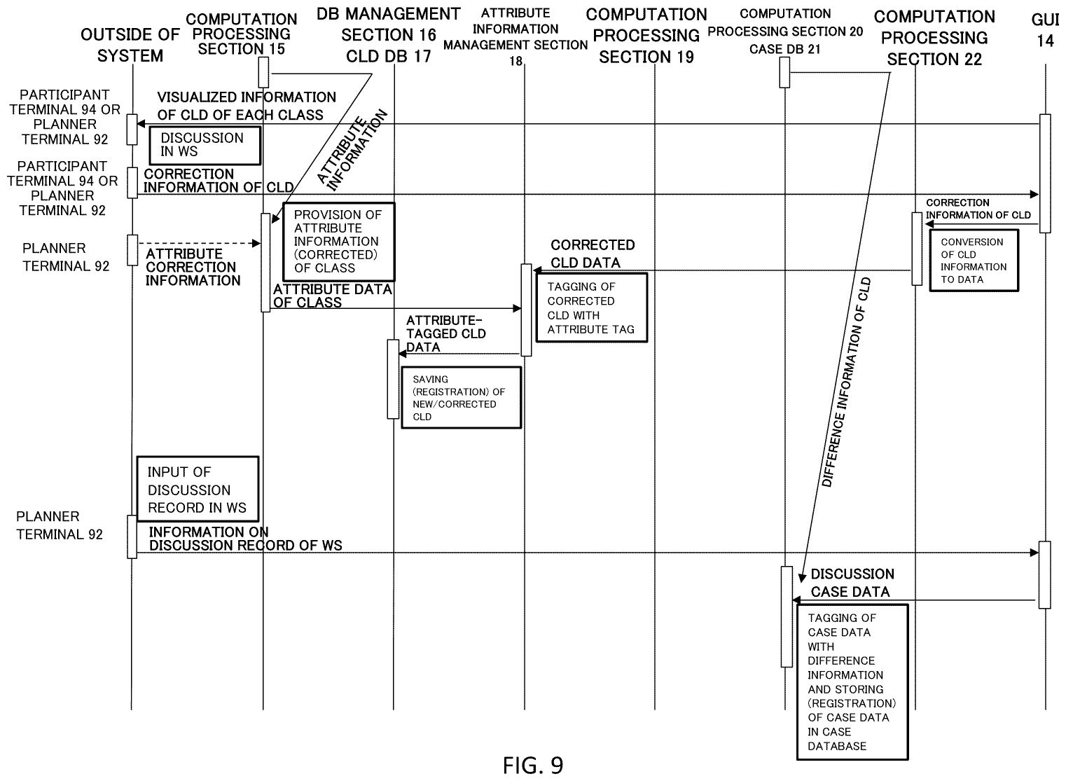

FIG. 8 is a diagram illustrating a flow of information in the CLD visualization system in the database expansion. FIG. 9 is a diagram illustrating a flow of processing in the CLD visualization system in the database expansion. The “database expansion” mentioned here includes creation and updating of the databases.

The participants 93 of a workshop or the like are grouped into a plurality of classes by clustering by the computation processing section 15. The participants 93 who belong to the class can check whether or not a CLD created for their own class matches the sentiment, and correct the CLD according to need. At this time, there is no need to correct the whole of the CLD, and partial correction may be added to the CLD. For example, correction may be executed only about the causal relation between KPIs relating to an issue to which attention is paid.

As described above, the computation processing section 19 creates the CLD of each class by processing of causing mutual complement of one or more CLDs that have similar attributes and that have been created in past workshops and the like and been accumulated in the CLD database 17. Therefore, it can be expected that creation of the CLD that matches the sentiment of the participants 93 at a higher degree is allowed by accumulating a large number of CLDs in the CLD database 17.

### Screen Display in CLD Correction

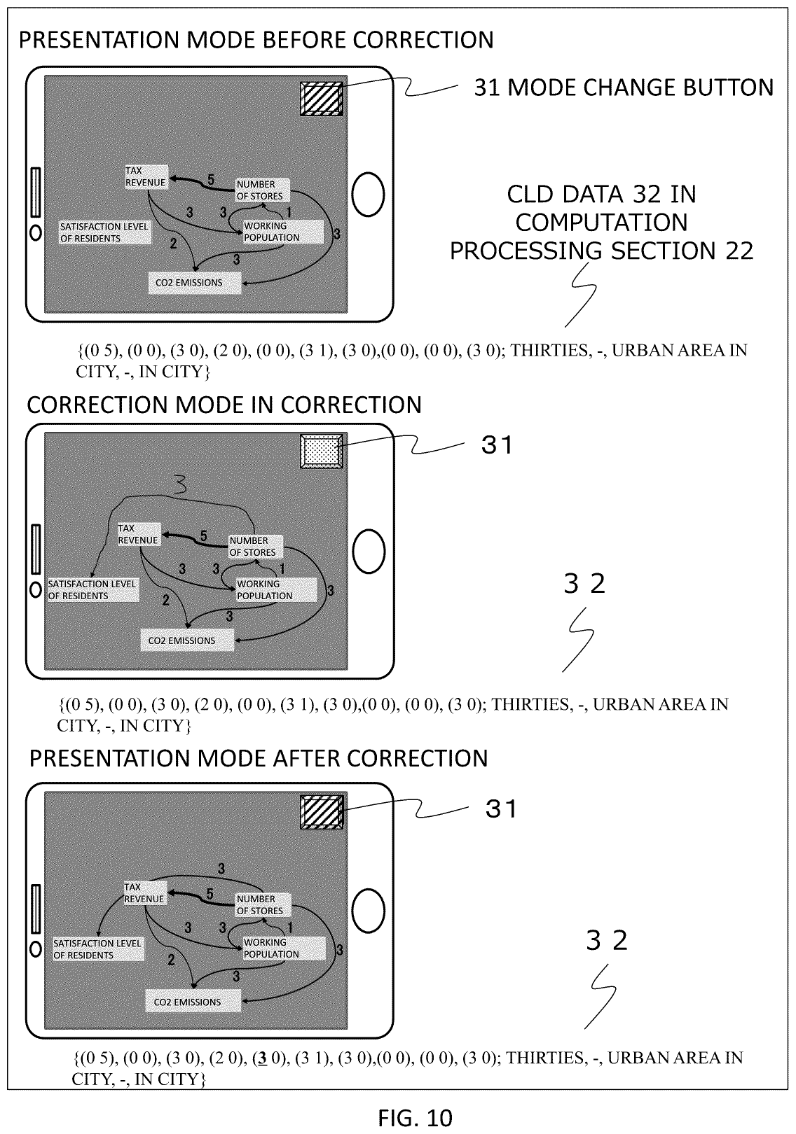

FIG. 10 is a diagram illustrating one example of screen transition on the participant terminal at the time of CLD correction by the participant.

Data in the screen on the participant terminal 94 is generated by the computation processing section 22 of the visualization function section 13 and is transmitted to the participant terminal 94 through the Internet. The relevant image can be switched to a mode in which correction of the CLD is possible (correction mode) and a mode in which correction of the CLD is impossible (presentation mode), by operation on a mode change button 31 by the participant 93. In FIG. 10, the mode change button 31 given hatching with dots represents the correction mode, and the mode change button 31 given hatching with oblique lines represents the presentation mode. Further, CLD data 32 inside the computation processing section 22 is illustrated in FIG. 10.

At an upper stage of FIG. 10, the presentation mode before correction (initial state), in which editing of the CLD is impossible, is illustrated. When desiring to add correction to the CLD, the participant 93 taps the icon of the mode change button 31 to make a change to the correction mode. At a middle stage of FIG. 10, the correction mode in correction, in which editing of the CLD is possible, is illustrated. The participant 93 edits the CLD on the touch panel and then taps the mode change button 31 again. Thereupon, the changed part is converted to data by the computation processing section 22, and the change in the CLD on the screen is settled. In the example of FIG. 10, the state in which correction has been added to the CLD by handwriting is illustrated in the screen at the middle stage. When the mode change button 31 is tapped in this state, the changed part is converted to data, and the change in the CLD is settled as in the screen on a lower stage. At this time, the CLD data 32 inside the computation processing section 22 is also changed.

Moreover, separately, the planner 91 inputs an issue discussed in a workshop or the like and the contents of the discussion as a case. The input case is sent from the computation processing section 22 of the visualization function section 13 to the computation processing section 20 of the problem search function section 12 together with data of the corrected CLD. The computation processing section 20 extracts again the difference information to which the corrected CLD relates, tags the case with the difference information, and registers the case in the case database 21.

The data of the changed CLD of each class is sent also to the attribute information management section 18. The attribute information management section 18 tags the changed CLD with the attribute of the relevant class, and registers the CLD in the CLD database 17 via the database management section 16. For example, assuming that all of the participants 93 who belong to a class have corrected the CLD, new CLD data are generated by the number of participants 93 who belong to this class.

Note that the expansion method for the databases is not limited to the above-described method. As another method, an attribute may be defined regarding each class by a predetermined determination method, and data of a CLD given one attribute tag may be created for each class and be registered in the CLD database 17. In this case, in the determination method for the attribute, a determination expression that is a definition expression representing the determination method may be defined in the definition hierarchical level of (2) in the method for storing data in the CLD database 17 exemplified in FIG. 4.

### System Application Example

Next, a workshop operation system to which the CLD visualization system 10 of the present embodiment is applied will be described.

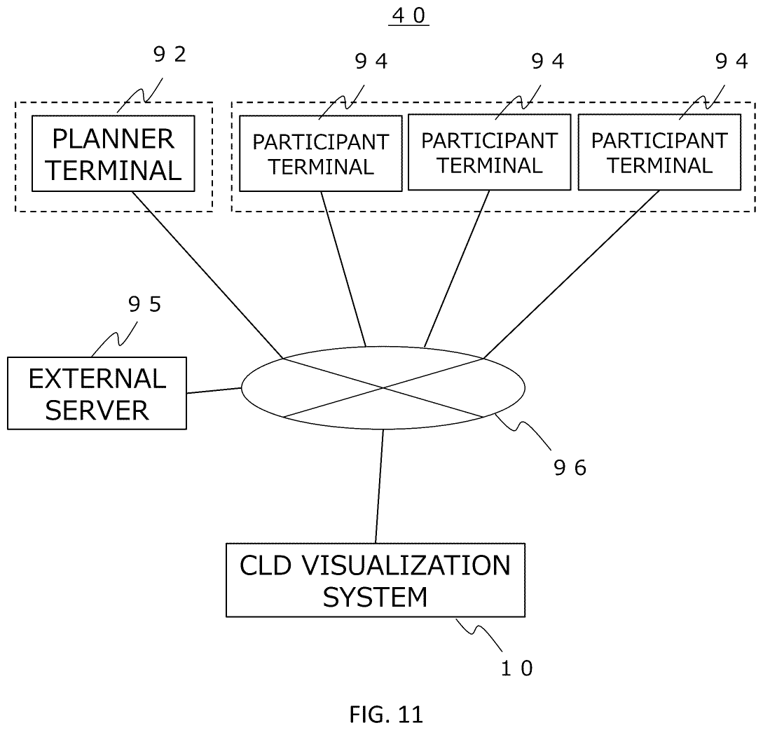

FIG. 11 is a block diagram illustrating a configuration of the workshop operation system.

A workshop operation system 40 has the CLD visualization system 10, the planner terminal 92, and the participant terminals 94. The CLD visualization system 10, the planner terminal 92, and the participant terminals 94 are the same as those described above. The participant terminal 94 may be a terminal owned by the participant oneself and be, for example, a smartphone, a PC, a wristband-type sensor, an AI speaker, or the like. The CLD visualization system 10, the planner terminal 92, and the participant terminals 94 can mutually connect through a communication network 96, and can mutually exchange information and/or data through the communication network 96. The communication network 96 is not limited to any particular kind and is, for example, a wide area network (WAN), a local area network (LAN), the Internet, or the like.

Moreover, the CLD visualization system 10, the planner terminal 92, and the participant terminals 94 can connect to an external server 95 through the communication network 96. The external server 95 is not limited to any particular kind. For example, the external server 95 may be a server in an information provision service company, a data center, or the like and provide free open information and paid information to the CLD visualization system 10.

The CLD visualization system 10 may release data of a CLD created in a workshop to allow the participants 93 and the like to view the data. On that occasion, the CLD of each class may be allowed to be set to give a right to view the CLD to only the participants 93 who belong to the relevant class. For example, it is also possible to employ operation in which discussion is advanced in a workshop in such a manner that sharing of the CLD is confined to sharing among the participants 93 of the same class and an issue and the difference information of the CLD are shared by all participants 93.

### Supplementary Note

According to the present embodiment described above, when it is necessary to form agreement between stakeholders with different interests on an occasion of decision-making, such as a workshop and measure formulation, a CLD that matches the sentiment can be generated and presented to each stakeholder. Further, according to the present embodiment, the participant 93 can obtain a CLD close to one's own sentiment without through complicated work of creation of the CLD by the participant 93 oneself. Moreover, in the present embodiment, the issue that should be discussed is automatically extracted and is shared by the respective stakeholders. Therefore, initial recognitions of all participants 93 for starting the discussion can be made common. Mainly regarding KPIs and the causal relation between the KPIs that become the issue, the respective stakeholders can mutually recognize change in the KPI of another stakeholder, recognize the circumstances of the other side on the evidence base, and understand each other. Further, it becomes possible to easily generate the CLD that matches the sentiment of each stakeholder and prompt formation of agreement without through a complicated adjustment process.

Items depicted below are included in the present embodiment described above. However, items included in the present embodiment are not limited to those depicted below.

### Item 1

An information processing device supports formation of agreement by a plurality of participants, the information processing device including a processor, and a memory that stores a causal loop diagram database in which attributes of participants and causal loop diagrams that conform to the attributes are accumulated in association with each other, the causal loop diagrams visualizing causal relations between evaluation indicators and causal relation strength that represents strength of the causal relations. The processor classifies the plurality of participants into a plurality of classes on the basis of input information relating to attributes of the plurality of participants and generates class attributes indicating attributes of each of the plurality of classes, and refers to the causal loop diagram database on the basis of the class attributes of the plurality of classes and creates a class causal loop diagram that is a causal loop diagram of each of the classes. The processor further extracts a difference regarding the causal relations and the causal relation strength between a plurality of the class causal loop diagrams and generates difference information indicating the difference, identifies an issue to be discussed to form the agreement, on the basis of the difference information, and presents the issue to the participants. According to this, the issue that should be discussed is identified on the basis of the difference in the causal relations between the evaluation indicators regarding each of the classes into which the participants are classified. Therefore, it becomes possible to effectively support formation of agreement by the plurality of participants.

### Item 2

In the information processing device according to Item 1, the processor classifies the plurality of participants into the plurality of classes by clustering of the participants based on the input information. This can easily execute grouping of the participants by the clustering.

### Item 3

In the information processing device according to Item 1, the memory further stores a case database in which the difference information and cases including an issue for which a difference represented by the difference information has occurred and contents of discussion are accumulated in association with each other, and the processor refers to the case database on the basis of the difference information extracted and extracts the case that matches the difference represented by the difference information, and presents the issue and the contents of discussion in the case to the participants. According to this, the issue and the contents of discussion are presented to the participants on the basis of the case for which the difference that has occurred in the causal relations is similar. Therefore, agreement formation by discussion among the participants can be promoted.

### Item 4

In the information processing device according to Item 1, the attributes include one or more of gender, age, an age group, occupation, a place of residence, a place of work, and income. This makes it possible to group the participants who are at similar situations.

### Item 5

In the information processing device according to Item 1, the processor presents the class causal loop diagram to the participants, and allows the participants to add and delete the causal relation in the class causal loop diagram and to change the causal relation strength of the causal relation. This can provide a user interface that allows the participants to easily understand and change the causal loop diagram.

### Item 6

In the information processing device according to Item 5, the processor presents the class causal loop diagram to only the participants who belong to a relevant one of the classes that corresponds to the class causal loop diagram. According to this, by limiting viewing of the causal loop diagram by the participants to viewing of the causal loop diagram of the participants' own class, consultation or the like by the participants in the class is enabled with separation from the participants of the other classes.

### Item 7

In the information processing device according to Item 1, the processor refers to the causal loop diagram database and extracts an item of a corresponding one of the attributes that is associated with the causal loop diagram, decides an item of a corresponding one of the attributes that is to be acquired from the participants, on the basis of the item extracted, and transmits an inquiry about information on the item decided to the participants. According to this, the item of the attribute that should be acquired from the participants is extracted from the database. Therefore, the item of the attribute that should be acquired from the participants can easily be identified.

### Item 8

In the information processing device according to Item 1, the processor searches the causal loop diagram database to identify the causal loop diagrams corresponding to the class attributes, and creates the class causal loop diagram by merging the causal loop diagrams identified. This can easily create the appropriate class causal loop diagram on the basis of information on the causal loop diagrams compiled into the database.

### Item 9

In the information processing device according to Item 1, the processor accepts correction for the class causal loop diagram from a participant who belongs to a relevant one of the classes, corrects the class causal loop diagram, and registers the class causal loop diagram corrected in the causal loop diagram database in association with the class attributes of the class. According to this, by registering the created causal loop diagram in the database, expansion of the database for later operation is enabled.

### Item 10

An information processing method supports formation of agreement by a plurality of participants by use of a computer having a processor and a memory. The information processing method includes, by the memory, storing a causal loop diagram database in which attributes of participants and causal loop diagrams that conform to the attributes are accumulated in association with each other, the causal loop diagrams visualizing causal relations between evaluation indicators and causal relation strength that represents strength of the causal relations. The information processing method further includes, by the processor, classifying the plurality of participants into a plurality of classes on the basis of input information relating to attributes of the plurality of participants and generating class attributes indicating attributes of each of the plurality of classes, and by the processor, referring to the causal loop diagram database on the basis of the class attributes of the plurality of classes and creating a class causal loop diagram that is a causal loop diagram of each of the classes. The information processing method further includes, by the processor, extracting a difference regarding the causal relations and the causal relation strength between a plurality of the class causal loop diagrams and generating difference information indicating the difference, by the processor, identifying an issue to be discussed to form the agreement, on the basis of the difference information, and by the processor, presenting the issue to the participants.

What is claimed is:

1. An information processing device that supports formation of agreement by a plurality of participants, the information processing device comprising:
a processor; and
a memory that stores a causal loop diagram database in which attributes of participants and causal loop diagrams that conform to the attributes are accumulated in association with each other, the causal loop diagrams visualizing causal relations between evaluation indicators and causal relation strength that represents strength of the causal relations, wherein
the processor
classifies the plurality of participants into a plurality of classes on a basis of input information relating to attributes of the plurality of participants and generates class attributes indicating attributes of each of the plurality of classes,
refers to the causal loop diagram database on a basis of the class attributes of the plurality of classes and creates a class causal loop diagram that is a causal loop diagram of each of the classes,
extracts a difference regarding the causal relations and the causal relation strength between a plurality of the class causal loop diagrams and generates difference information indicating the difference,
identifies an issue to be discussed to form the agreement, on a basis of the difference information, and
presents the issue to the participants.

2. The information processing device according to claim 1, wherein
the processor classifies the plurality of participants into the plurality of classes by clustering of the participants based on the input information.

3. The information processing device according to claim 1, wherein
the memory further stores a case database in which the difference information and cases including an issue for which a difference represented by the difference information has occurred and contents of discussion are accumulated in association with each other, and
the processor
refers to the case database on a basis of the difference information extracted and extracts the case that matches the difference represented by the difference information, and
presents the issue and the contents of discussion in the case to the participants.

4. The information processing device according to claim 1, wherein
the attributes include one or more of gender, age, an age group, occupation, a place of residence, a place of work, and income.

5. The information processing device according to claim 1, wherein
the processor
presents the class causal loop diagram to the participants, and
allows the participants to add and delete the causal relation in the class causal loop diagram and to change the causal relation strength of the causal relation.

6. The information processing device according to claim 5, wherein
the processor presents the class causal loop diagram to only the participants who belong to a relevant one of the classes that corresponds to the class causal loop diagram.

7. The information processing device according to claim 1, wherein
the processor
refers to the causal loop diagram database and extracts an item of a corresponding one of the attributes that is associated with the causal loop diagram,
decides an item of a corresponding one of the attributes that is to be acquired from the participants, on a basis of the item extracted, and
transmits an inquiry about information on the item decided to the participants.

8. The information processing device according to claim 1, wherein
the processor
searches the causal loop diagram database to identify the causal loop diagrams corresponding to the class attributes, and
creates the class causal loop diagram by merging the causal loop diagrams identified.

9. The information processing device according to claim 1, wherein
the processor
accepts correction for the class causal loop diagram from a participant who belongs to a relevant one of the classes,
corrects the class causal loop diagram, and
registers the class causal loop diagram corrected in the causal loop diagram database in association with the class attributes of the class.

10. An information processing method for supporting formation of agreement by a plurality of participants by use of a computer having a processor and a memory, the information processing method comprising:
by the memory, storing a causal loop diagram database in which attributes of participants and causal loop diagrams that conform to the attributes are accumulated in association with each other, the causal loop diagrams visualizing causal relations between evaluation indicators and causal relation strength that represents strength of the causal relations;
by the processor, classifying the plurality of participants into a plurality of classes on a basis of input information relating to attributes of the plurality of participants and generating class attributes indicating attributes of each of the plurality of classes;
by the processor, referring to the causal loop diagram database on a basis of the class attributes of the plurality of classes and creating a class causal loop diagram that is a causal loop diagram of each of the classes;
by the processor, extracting a difference regarding the causal relations and the causal relation strength between a plurality of the class causal loop diagrams and generating difference information indicating the difference;
by the processor, identifying an issue to be discussed to form the agreement, on a basis of the difference information; and
by the processor, presenting the issue to the participants.
